(19) United States
(12) Patent Application Publication
(10) Pub. No.: US 2019/0150457 A1
(43) Pub. Date: May 23, 2019

(54) MANUFACTURE OF LACTIC ACID-FERMENTED BATTER

(71) Applicant: DuPont Nutrition Biosciences APS, Copenhagen (DK)

(72) Inventors: Pascal Fourcassie, Poitiers (FR); Keshav Krishnamani, Colombier (CH)

(21) Appl. No.: 16/078,867

(22) PCT Filed: Feb. 16, 2017
(86) PCT No.: PCT/EP2017/053527

§ 371 Date: Aug. 22, 2018

(30) Foreign Application Priority Data
Feb. 17, 2016 (EP) 16156180.8
Feb. 17, 2016 (IN) 201611005521

(51) Int. Cl. A21D 8/04; A21D 13/045; A21D 13/047; A21D 10/04; A21D 13/44

(52) U.S. Cl. CPC A21D 8/045; A21D 13/045; A21D 13/047; A21D 10/04; C12R 1/25; A23Y 2220/67; A23Y 2260/35; A23Y 2280/55; A21D 13/44

(57) ABSTRACT

The present invention relates to a culture or kit-of-part comprising or consisting of a Lactobacillus plantarum strain and Leuconostoc spp strain(s), and uses thereof to manufacture a millet-, sorghum-, lentil-, pea-, rice- or teff-based lactic acid-fermented batter, in particular a batter for Dosa or Idli application.

### FIELD OF THE INVENTION

The present invention relates to a culture or kit-of-part comprising or consisting of a Lactobacillus plantarum strain and Leuconostoc spp strain(s), and uses thereof to manufacture a millet-, sorghum-, lentil-, pea-, rice- or teff-based lactic acid-fermented batter, in particular a batter for Dosa or Idli application.

### BACKGROUND OF THE INVENTION

Cereal/legume-based foods are a major source of economical dietary energy and nutrients, worldwide. Among the fermented food in India, Dosa and Idli are two very popular fermented foods made of a mixture of cereal and legume. A very large proportion of such traditional fermented foods are still being prepared on a traditional basis, in particular at a household level, on a small-scale by means of natural fermentation. Various microbiological analysis of both Dosa and Idli have revealed that the microorganisms involved in the leavening of the Dosa or Idli batter as well as acid production during natural or traditional fermentation are essentially lactic acid bacteria and yeast. The lactic acid bacteria commonly cited include Leuconostoc mesenteroides, Streptococcus faecalis, Lactobacillus fermentum, Bacillus amyloliquefaciens, Lactobacillus delbrueckii, Bacillus polymyxa, Pediococcus cerevisiae, Bacilus subtilis, Pediococcus pentosaceus, Pediococcus acidilacti, Leuconostoc paramesenteroides, Lactobacillus casei, Lactobacillus coryniformis, Lactobacillus brevis, Lactobacillus confusus and Lactobacillus cellobiosus, whereas the yeast include Saccharomyces cerevisiae, Debaryomyces Hansenii, Trichosporon beigelli, Torulopsis candida, Trichosporon pullulans, Candida fragicola and Candida tropicalis.

With the growing demand for commercial batter for Dosa or Idli, there is a need for an industrial production of batter for Dosa or Idli. The production of batter for Dosa or Idli applications at the industrial scale involves the packing of the batter in pouches which requires the stability of the batter product in the pouches between its production and its consumption. However, gas production within the pouches have been reported and are considered to highly impact not only the possibility to store the pouches for extended period of time and to transport the pouches to place of consumption, but also the quality of the batter product.

Patent application IN192486 reports an improved process for the preparation of a batter for Idli application having increase shelf life. Thus, this application reports in situ fermentation of a batter for Idli using a culture consisting of Lactobacillus brevis, Pediococcus pentosaceus and Candida versatilis. Thus, the batter is inoculated with a cell suspension of Lactobacillus brevis, Pediococcus pentosaceus and Candida versatilis. The inoculated batter is then immediately distributed in pouches which are then sealed and incubated at 30° C. Thus, the fermentation takes place within the pouches (in situ fermentation). However, the process disclosed in patent application IN192486 is rendered particularly complex by the requirement of producing several individual culture suspensions of each bacteria or yeast.

Therefore, there is a need for a simplified method to manufacture—at the industrial scale—batter for Dosa or Idli applications, and more generally millet-, sorghum-, lentil-, pea-, rice- or teff-based lactic acid-fermented batter, such that the pH and the CO₂ production of the batter can be obtained in a satisfying time and that the lactic-acid fermented batter once packaged has an improved extended shelf life while maintaining its quality.

### DESCRIPTION OF THE FIGURES

FIG. 1: pH and % CO₂ (% vol) versus time (hours) of batter inoculated with the composition 1, 11 or 12

### DESCRIPTION OF THE INVENTION

The inventors have surprisingly put in evidence that the use of a Lactobacillus plantarum strain and Leuconostoc spp strain(s) as described herein during the manufacture of lactic acid-fermented batter (such as a millet-, sorghum-, lentil-, pea-, rice- or teff-based, lactic acid-fermented, batter) provides the following advantages, as compared to control lactic acid-fermented batter:
acidification of the batter, by lactic acid production (fermentation), to reach a pH value between 3.5 and 4.5, at ambient temperature, for example between 25 and 35° C., such as at 30° C.;
efficient CO₂ production during fermentation of the batter;
reduced CO₂ production during storage of the lactic acid-fermented batter;
shelf life extended up to 25 days at refrigerated temperature (such as between 2 and 10° C.); and
high quality of the obtained lactic-acid fermented batter (low or absence of sedimentation).

In accordance with these findings, the invention is directed to a method to produce, a millet-, sorghum-, lentil-, pea-, rice- or teff-based, lactic acid-fermented, batter, comprising:
a) providing a millet-, sorghum-, lentil-, pea-, rice- or teff-based batter;
b) adding to said batter, a Lactobacillus plantarum strain and Leuconostoc spp strain(s); and
c) incubating said batter obtained in b) at an appropriate temperature, to obtain by lactic acid fermentation a millet-, sorghum-, lentil-, pea-, rice- or teff-based lactic acid-fermented batter;

wherein each of Lactobacillus plantarum strain and of Leuconostoc spp strain(s) is added, in step b), at a concentration of at least 10⁵ cfu/g of batter.

In a particular embodiment, the method as described herein is to produce a lactic-acid fermented batter for Dosa or for Idli application (herein termed “Dosa or Idli batter’).

Herein, the term “batter” is defined as commonly acknowledged in the art, i.e., a suspension or solution of ground grains/seeds in an aqueous medium, in particular water. Batter is commonly made by combining one or more dry flours with liquid (such as water). Batter can also be made by soaking grains in water and grinding them wet (wet grinding); in this embodiment, when grains of different origins are used, grains are soaked and grinded separately, and the different obtained pastes are mixed together. The preparation of the batter also comprises the possible addition of ingredients other than grains (and other than microorganisms), such as sugar, salt or flavorings such as herbs, spice.

Within the invention, the batter is a millet-, sorghum-, lentil-, pea-, rice- or teff-based batter. This batter can be obtained by soaking, grinding and possibly mixing grains of millet, sorghum, lentil, pea, rice and/or teff. In an embodiment, the batter is a lentil-based batter, such as black gram-based batter or pea-based batter such as bengal gram-based batter. In an embodiment, the batter is a rice- or teff-based batter. In a particular embodiment, the batter is a mixture or paste of rice and black gram or a mixture or paste of rice flour and benghal gram. When mixing rice with black gram or with benghal gram, the ratio rice over black gram or rice over benghal gram is in particular between 2:1 and 5:1 (w/w). In a particular embodiment, there is no wheatgrass or wheatgrass powder present or added to the batter.

“Lactic acid-fermented batter” means a batter whose pH has been decreased after fermentation and lactic acid production by microorganisms, including lactic acid bacteria. In a particular embodiment, the lactic acid-fermented batter as defined herein is not a ready-to-eat product. Thus, heat is applied to the lactic acid-fermented batter, in particular by frying, baking or steaming, in order to cook it and to “set” the batter into a solid form. In a particular embodiment, the batter is used for fried snack.

The term “adding” means put in contact the batter with the Lactobacillus plantarum strain and Leuconostoc spp strain(s). The term “adding” encompass the term “inoculating”, i.e., that the addition of the Lactobacillus plantarum strain and Leuconostoc spp strain(s) into the batter is done such that the Lactobacillus plantarum strain and Leuconostoc spp strain(s) are able to be metabolically active, in order to produce lactic acid and/or CO₂.

The addition or inoculation of the Lactobacillus plantarum strain and Leuconostoc spp strain(s) in step b) can be done as two separate cultures or as a mixture. When the Lactobacillus plantarum strain and the Leuconostoc spp strain(s) are separated, they can be added separately or simultaneously in time during the addition or inoculation step. The expression “as a mixture”, means that the Lactobacillus plantarum strain and Leuconostoc spp strain(s) are previously mixed to form a culture (or composition) before their addition or inoculation.

Both Lactobacillus plantarum strain and Leuconostoc spp strain(s) added in step b) of the present method are sufficient to produce a lactic-acid fermented batter from a batter, provided that each of Lactobacillus plantarum strain and of Leuconostoc spp strain(s) is added, in step b), at a concentration of at least 10⁵ cfu (colony forming units) per g of batter. By “at least 10⁵ cfu/g of batter”, it means at least 10⁵ cfu/g, at least 10⁶ cfu/g, at least 10⁷ cfu/g or at least 10⁸ cfu/g of batter. The concentration of added Lactobacillus plantarum strain and the concentration of added Leuconostoc spp strain(s) are selected independently. Any concentration expressed in “10^{x} cfu/g” within this application is to be understood as 10^{x}±a half log of 10^{x} cfu/g (for example 10⁵ cfu/g means 10⁵±a half log of 10⁵, i.e. between 5.10⁴ and 5.10⁵ cfu/g).

The Lactobacillus plantarum strain and Leuconostoc spp strain(s) can be added or inoculated under any form, such as under frozen, dried, freeze-dried, liquid or solid format, in the form of pellets or frozen pellets, or in a powder or dried powder. When the Lactobacillus plantarum strain and Leuconostoc spp strain(s) are added or inoculated separately, the Lactobacillus plantarum strain on one hand and Leuconostoc spp strain(s) on the other can be under the same format or under different formats.

Thus, whatever the form, the concentration of the Lactobacillus plantarum strain and the concentration of the Leuconostoc spp strain(s) are, each separately, in the range of 10⁵ to 10¹² cfu per g of culture or mixture, and more preferably at least 10⁶, at least 10⁷, at least 10⁸, at least 10⁹, at least 10¹⁰, at least 10¹¹ or at least 10¹² cfu/g of culture or mixture.

In an advantage of the invention, the Lactobacillus plantarum strain and Leuconostoc spp strain(s) are directly added into the batter. By “directly added”, it is meant that the culture or the cultures is/are concentrated enough to be added or inoculated into the batter (such as frozen or dried concentrate) without previous propagation. The expression “directly added” encompasses both the inoculation of frozen or dried concentrate(s) of Lactobacillus plantarum strain and Leuconostoc spp strain(s) into the batter, and the inoculation of frozen or dried concentrate(s) of Lactobacillus plantarum strain and Leuconostoc spp strain(s) under a diluted form prior to inoculation (such as for example dilution of the concentrate(s) into water). In a particular embodiment, the Lactobacillus plantarum strain and Leuconostoc spp strain(s) are directly added or inoculated into the batter in a frozen format or as frozen pellets. In another embodiment of the invention, the Lactobacillus plantarum strain and Leuconostoc spp strain(s) are directly added or inoculated into the batter under a powder form, such as a dried or freeze-dried powder. In another embodiment, the Lactobacillus plantarum strain and Leuconostoc spp strain(s) are directly added or inoculated into the batter under a diluted form of frozen or dried concentrates of Lactobacillus plantarum strain and Leuconostoc spp strain(s). Thus, as separate cultures, the concentration of the Lactobacillus plantarum strain concentrate and the concentration of the Leuconostoc spp strain(s) concentrate are, each separately, in the range of 10⁸ to 10¹² cfu per g of culture or mixture, and more preferably at least 10⁸, at least 10⁹, at least 10¹⁰, at least 10¹¹ or at least 10¹² cfu/g of culture. As a mixture, the concentration of the concentrate comprising or consisting of Lactobacillus plantarum strain and Leuconostoc spp strain(s) is in the range of 10⁸ to 10¹² cfu per g of mixture, and more preferably at least 10⁸, at least 10⁹, at least 10¹⁰, at least 10¹¹ or at least 10¹² cfu/g of mixture.

In a particular embodiment, the ratio of the Lactobacillus plantarum strain over the Leuconostoc spp strain(s) [calculated in cfu] is between 1:1 and 20:1. In particular, said ratio is between 1:1 and 10:1. In a particular embodiment, said ratio is between 2:1 or 1:1 and a maximal value selected from the group consisting of 9:1, 8:1, 7:1, 6:1, 5:1, 4:1 and 3:1.

The expression “Leuconostoc spp strain(s)” means one or several strains of the genus Leuconostoc, in particular 1, 3, 3, 4 or 5 strains of the genus Leuconostoc. In a particular embodiment, at least one or all the strains of the genus Leuconostoc are from the species Leuconostoc mesenteroides.

Any combination of Lactobacillus plantarum strain and Leuconostoc spp strain(s) (and ratio thereof) can be used as long as the pH of the lactic-acid fermented batter obtained by the present method can reach a value between 3.5 and 4.5 after incubation. As example, the Lactobacillus plantarum strain and the Leuconostoc spp strain(s) can be selected together using the assay A described herein.

Assay A: parboiled Rice grains (Top Budget brand) are soaked with sterile water (3 parts of grains, 1 part of water) during 4 hours at 25° C. Dehulled black gram grains (Spencer's brand, India) are soaked with sterile water (3 parts of gram/1 part of water) during 4 hours at 25° C. Each soaked product is drained. The final ratio between grains and water is adjusted to 1 part of soaked grains or gram for 1.25 part of sterile water. Then, soaked rice grains and soaked black gram are wet grinded separately with a wet grinder device (type Butterfly brand, matchless). The two products are mixed together, after having being grinded separately, at a ratio of 3 parts of rice batter with 1 part of black gram batter. In the final mix batter, 1% (w/w) NaCl and 0.1% (w/w) fenugreek powder (Valga brand, india) are added to obtain the final recipe of Dosa/Idli batter medium (model medium). A culture (provided as a lyophilized concentrate, the concentration of which is between 10⁸ and 10¹² cfu/g of culture) was directly inoculated at a rate of 10⁶ cfu/ml of batter medium. 100 ml of batter is then placed in specific flask of 500 ml equipped with a pH probe and a system to measure CO₂ in the head space (BCP-CO₂, gas sensor system provided by Bluesens GmbH company). The BCP-CO₂ system used measures the concentration in CO₂ in a gas for a range of 0-25% (vol/vol) CO₂ at 25° C. by IR light intensity absorption inside a specific closed cap sealed on the top of the flask. The flask is displayed in a water bath thermo-regulated at a temperature of 30° C.±0.5° C. pH evolution is measured with an on-line measurement system, Cinac system (Corrieu G. et al. 1992) and CO₂ production is assessed with the CO₂ measurement system (gas sensor system provided by Bluesens GmbH company). pH and CO₂ concentration evolutions are plotted versus time and the pH value 16 h after inoculation, and optionally the CO₂ concentration 16 h after inoculation, are used to select the appropriate combination of Lactobacillus plantarum strain and Leuconostoc spp strain(s).

In a particular embodiment, the Lactobacillus plantarum strain and the Leuconostoc spp strain(s), and in particular ratio thereof, are selected such that, when added to the model medium (the Dosa/Idli batter medium of assay A), a culture comprising or consisting of said Lactobacillus plantarum strain and said Leuconostoc spp strain(s) enables said model medium to reach a pH between 3.5 and 4.5, 16 hours after its addition, in particular to reach a pH between 3.6 and 4.4, more particularly between 3.8 and 4.2, 16 hours after its addition, when tested by assay A.

In an optional embodiment, in combination with the previous one, the Lactobacillus plantarum strain and the Leuconostoc spp strain(s), and in particular ratio thereof, are selected such that when added to the model medium (the Dosa/Idli batter medium of assay A), a culture comprising or consisting of said Lactobacillus plantarum strain and said Leuconostoc spp strain(s) produces CO₂ in an amount than is less than 15% vol., 16 hours after its addition, as tested by assay A. In a particular embodiment, said culture comprising or consisting of said Lactobacillus plantarum strain and said Leuconostoc spp strain(s) produces CO₂ in an amount which is between 2% and 15% vol., 16 hours after its addition, as tested by assay A, in particular in an amount between 3% and 15% vol, 4% and 15% vol, 5% and 15% vol, 6% and 15% vol, 7% and 15% vol and 8% and 15% vol.

In an embodiment, the Lactobacillus plantarum strain added or inoculated in step b) of the method is the Lactobacillus plantarum strain deposited at the DSMZ under accession number DSM25833 on Apr. 3, 2012.

In an embodiment, the Lactobacillus plantarum strain added or inoculated in step b) of the method is a variant of said DSM25833 strain, wherein said variant keeps the functionalities of the DSM25833 strain in terms of pH value, and optionally CO₂ production when combined with Leuconostoc spp strain(s) [wherein the pH value and CO₂ production are calculated as described in Assay A]. A variant is herein defined as a Lactobacillus plantarum strain presenting at least one mutation, such as the addition, deletion, insertion and/or substitution of at least one nucleotide in its genome as compared to the DSM25833 strain. In a particular embodiment, the genome sequence of the variant has an identity of at least 90%, at least 91%, at least 92%, at least 93%, at least 94%, at least 95%, at least 96%, at least 97%, at least 98%, at least 99%, at least 99.1%, at least 99.2%, at least 99.3%, at least 99.4%, at least 99.5%, at least 99.6%, at least 99.7%, at least 99.8%, at least 99.9%, at least 99.92%, at least 99.94%, at least 99.96%, at least 99.98%, or at least 99.99% to the genome sequence of the DSM25833 strain. Such a variant can be:

a natural variant obtained spontaneously from the DSM25833 strain after incubation in a selection medium. A natural variant is thus obtained without any genetic manipulation but only by natural mutation of the strain and selection of the strain in an appropriate medium; or

a variant comprising at least one mutation in its genome, said mutation being induced by genetic engineering, for instance by directed mutagenesis or random mutagenesis. Random mutagenesis can be performed with UV radiations or mutagenic compounds such as nitrous acid, ethyl-methanesulfonate, NMethyl-N′-nitro-N-nitrosoguanidine, N-ethyl-N-nitrosourea, acridine orange, proflavine.

In an embodiment, the only microorganisms added or inoculated into the batter are the Lactobacillus plantarum strain and the Leuconostoc spp strain(s) as defined herein. In another embodiment, in addition to the Lactobacillus plantarum strain and the Leuconostoc spp strain(s) as defined herein, at least one additional microorganism(s) and in particular 1, 2, 3, 4, 5 or 6 additional microorganism(s) is (are) added or inoculated into the batter. In a particular embodiment, said at least one additional microorganism is a yeast, in particular a yeast of the Debaryomyces genus. In a particular embodiment, said at least one additional microorganism is a lactic acid bacteria, in particular a lactic acid bacteria of the Pediococcus genus. In an embodiment, the microorganisms added or inoculated into the batter comprise or consist of the Lactobacillus plantarum strain and the Leuconostoc spp strain(s) as defined herein and a yeast, in particular a yeast of the Debaryomyces genus. In an embodiment, the microorganisms added or inoculated into the batter comprise or consist of the Lactobacillus plantarum strain and the Leuconostoc spp strain(s) as defined herein and a lactic acid bacteria, in particular a lactic acid bacteria of the Pediococcus genus. In an embodiment, the microorganisms added or inoculated into the batter comprise or consist of the Lactobacillus plantarum strain and the Leuconostoc spp strain(s) as defined herein, a yeast, in particular a yeast from the Debaryomyces genus and a lactic acid bacteria, in particular a lactic acid bacteria of the Pediococcus genus. When additional microorganism(s) as defined herein are added in addition to the Lactobacillus plantarum strain and the Leuconostoc spp strain(s) as defined herein, said additional microorganism(s) are added in a concentration (in cfu/g) that is, for each microorganism(s) and independently from each other, less than the concentration of the Lactobacillus plantarum strain and less than the concentration of the Leuconostoc spp strain(s). For example, if the Lactobacillus plantarum strain and the Leuconostoc spp strain(s) are added both at a concentration of 10⁵ cfu/g, the additional microorganism(s) are each added at a concentration of less than 10⁵ cfu/g. Typically, yeast, including yeast of the Debaryomyces genus, are added at a concentration between 10² and 10⁵ cfu/g of batter. Lactic acid bacteria, including bacteria of the Pediococcus genus, are added at a concentration between 10³ and 10⁶ cfu/g of batter.

“Incubating” means to maintain the millet-, sorghum-, lentil-, pea-, rice- or teff-based batter previously inoculated with at least the Lactobacillus plantarum strain and Leuconostoc spp strain(s) in appropriate conditions in order these strains produce lactic acid and thus decrease the pH of the batter, to obtain a lactic-acid fermented millet-, sorghum-, lentil-, pea-, rice- or teff-based batter. In an embodiment, the inoculated batter is incubated at a temperature ranging from 15 to 45° C., an in particular ranging from 15 to 30° C. (winter conditions) or ranging from 30 to 45° C. (summer conditions). In an embodiment, the incubation lasts until the pH value of the batter decreases from an initial pH value comprised between 5.6 and 6.5 to a pH value between 3.5 and 4.5, in particular between 3.6 and 4.4, preferably between 3.8 and 4.2. Typically, depending upon the temperature, the incubation lasts between 14 and 30 h, preferably between 16 and 24 h.

The incubating step can be performed in batch (i.e., outside of the packaging used for storage), or in the packaging used for storage or can be started outside of the packaging used for storage and continued into the packaging used for storage.

In a particular embodiment, at least the incubation step of the present method is carried out outside of the packaging used for storage, in particular in batch whose size is at least 10 litres, at least 20 litres or at least 30 litres of inoculated batter. In an embodiment, the invention is directed to a method to produce a packaging comprising a millet-, sorghum-, lentil-, pea-, rice- or teff-based lactic acid-fermented batter, in particular a Dosa or Idli batter, comprising:
a) providing a millet-, sorghum-, lentil-, pea-, rice- or teff-based batter;
b) adding to said batter, a Lactobacillus plantarum strain and Leuconostoc spp strain(s) as defined herein; and
c) incubating said batter obtained in b) at an appropriate temperature, to obtain by lactic acid fermentation a millet-, sorghum-, lentil-, pea-, rice- or teff-based lactic acid-fermented batter, in particular whose pH value is comprised between 3.5 and 4.5;
d) optionally, pasteurizing said lactic acid-fermented batter;
e) optionally, cooling said lactic acid-fermented batter or said pasteurized lactic acid-fermented batter; and
f) filing a packaging with said lactic acid-fermented batter, to obtain a packaging comprising a millet-, sorghum-, lentil-, pea-, rice- or teff-based lactic acid-fermented batter.

In a particular embodiment, the incubation step of the present method is carried out into the packaging used for storage. In an embodiment, the invention is directed to a method to produce a packaging comprising a millet-, sorghum-, lentil-, pea-, rice- or teff-based lactic acid-fermented batter, in particular a Dosa or Idli batter, comprising:
a) providing a millet-, sorghum-, lentil-, pea-, rice- or teff-based batter;
b) adding to said batter, a Lactobacillus plantarum strain and Leuconostoc spp strain(s) as defined herein;
c) filing a packaging used for storage with said batter obtained in b); and
d) incubating said batter—contained in the packaging—at an appropriate temperature, to obtain by lactic acid fermentation a packaging comprising a millet-, sorghum-, lentil-, pea-, rice- or teff-based lactic acid-fermented batter, in particular whose pH value is comprised between 3.5 and 4.5.

In a particular embodiment, the incubation step of the present method is started outside of the packaging used for storage and continued into the packaging used for storage. In an embodiment, the invention is directed to a method to produce a packaging comprising a millet-, sorghum-, lentil-, pea-, rice- or teff-based lactic acid-fermented batter, in particular a Dosa or Idli batter, comprising:
a) providing a millet-, sorghum-, lentil-, pea-, rice- or teff-based batter;
b) adding to said batter, a Lactobacillus plantarum strain and Leuconostoc spp strain(s) as defined herein;
c) incubating said batter obtained in b) at an appropriate temperature, to start the lactic acid fermentation of said millet-, sorghum-, lentil-, pea-, rice- or teff-based lactic acid-fermented batter,
d) filing a packaging with said batter which has been partially fermented in c)
e) incubating said batter—contained in the packaging—at an appropriate temperature, to obtain by lactic acid fermentation a packaging comprising a millet-, sorghum-, lentil-, pea-, rice- or teff-based lactic acid-fermented batter, in particular whose pH value is comprised between 3.5 and 4.5.

Packaging for storage of millet-, sorghum-, lentil-, pea-, rice- or teff-based lactic acid-fermented batter, in particular a Dosa or Idli batter, can be any packaging designed to contain batter such as boxes, bottles, pouches. Typically, said packaging containing the batter of the invention has a weight which is at least 100, 200, 300, 400 or 500 g. Typically, said packaging has a weight which is at least 500 g. In an embodiment, the weight of the packaging is 1 kg, 2 kg, 5 kg or 10 kg.

The invention is also directed to a millet-, sorghum-, lentil-, pea-, rice- or teff-based lactic acid-fermented batter, in particular a Dosa or Idli batter, obtained or obtainable by a method to produce, a millet-, sorghum-, lentil-, pea-, rice- or teff-based, lactic acid-fermented, batter, as described herein. Thus, the millet-, sorghum-, lentil-, pea-, rice- or teff-based lactic acid-fermented batter, in particular the Dosa or Idli batter, of the invention is characterized in that:
it contains a Lactobacillus plantarum strain and Leuconostoc spp strain(s), optionally at a total concentration of at least 10⁷ cfu/g, in particular comprised between 10⁷ to 10⁹ cfu/g or between 10⁷ to 10¹⁰ cfu/g of lactic acid-fermented batter (“total concentration” is defined herein as the concentration of both the Lactobacillus plantarum strain and Leuconostoc spp strain(s) calculated as whole), and
the pH of the lactic acid-fermented batter is comprised between 3.5 and 4.5, in particular between 3.6 and 4.5, preferably between 3.8 and 4.2.

The invention is also directed to a packaging as defined herein comprising a millet-, sorghum-, lentil-, pea-, rice- or teff-based lactic acid-fermented batter, in particular a Dosa or Idli batter obtained or obtainable by a method to produce, a millet-, sorghum-, lentil-, pea-, rice- or teff-based, lactic acid-fermented, batter, as described herein.

The invention is also directed to a culture or kit-of-part comprising or consisting of a Lactobacillus plantarum strain and Leuconostoc spp strain(s). The definitions used within the method as far as they concern the strains apply for the culture or the kit-of-part.

The Lactobacillus plantarum strain and Leuconostoc spp strain(s), either as a culture or as a kit-of-part, can be under any form suitable for addition or inoculation to the batter, such as under frozen, dried, freeze-dried, liquid or solid format, in the form of pellets or frozen pellets, or in a powder or dried powder. In an advantage of the invention, the Lactobacillus plantarum strain and Leuconostoc spp strain(s) are in a frozen format or in the form of pellets or frozen pellets, in particular contained into one or more box or sachet. In another advantage of the invention, the Lactobacillus plantarum strain and Leuconostoc spp strain(s) are under a powder form, such as a dried or freeze-dried powder, in particular contained into one or more box or sachet.

In a particular embodiment, the Lactobacillus plantarum strain and Leuconostoc spp strain(s), either as a culture or as a kit-of-part, are in a concentration such that they can be directly added or inoculated into the batter—i.e., without previous propagation—such as frozen or dried concentrate.

Thus, whatever the form, the concentration of the Lactobacillus plantarum strain and the concentration of the Leuconostoc spp strain(s) are, each separately, in the range of 10⁵ to 10¹² cfu per g of culture, and more preferably at least 10⁶, at least 10⁷, at least 10⁸, at least 10⁹, at least 10¹⁰, at least 10¹¹ or at least 10¹² cfu/g of culture. When in the form of frozen or dried concentrate, the concentration of the Lactobacillus plantarum strain and the concentration of the Leuconostoc spp strain(s) are, each separately, in the range of 10⁸ to 10¹² cfu/g of frozen concentrate or dried concentrate, and more preferably at least 10⁸, at least 10⁹, at least 10¹⁰, at least 10¹¹ or at least 10¹² cfu/g of frozen concentrate or dried concentrate.

The expression “A culture comprising or consisting of a Lactobacillus plantarum strain and Leuconostoc spp strain(s)” means that the Lactobacillus plantarum strain and the Leuconostoc spp strain(s) are physically mixed together. In an embodiment, the Lactobacillus plantarum strain and the Leuconostoc spp strain(s) are in the same box or in the same pouch. In an embodiment, when part of the same culture, the ratio of the Lactobacillus plantarum strain over the Leuconostoc spp strain(s) [calculated in cfu] is between 1:1 and 20:1. In particular, said ratio is between 1:1 and 10:1. In a particular embodiment, said ratio is between 2:1 or 1:1 and a maximal value selected from the group consisting of 9:1, 8:1, 7:1, 6:1, 5:1, 4:1 and 3:1.

In contrast, the expression “A kit-of-part comprising or consisting of a Lactobacillus plantarum strain and Leuconostoc spp strain(s)” means that the Lactobacillus plantarum strain culture and the Leuconostoc spp strain(s) culture are physically separated but intended to be used together. Thus, Lactobacillus plantarum strain and the Leuconostoc spp strain(s) are in different boxes or sachets. In an embodiment, the Lactobacillus plantarum strain and Leuconostoc spp strain(s) are under the same format, i.e, are in a frozen format, in the form of pellets or frozen pellets, a powder form, such as a dried or freeze-dried powder.

It is within the present invention that the culture or kit-of-part comprising or consisting of a Lactobacillus plantarum strain and Leuconostoc spp strain(s) is suitable for the manufacture of a millet-, sorghum-, lentil-, pea-, rice- or teff-based lactic acid-fermented batter, in particular a Dosa or Idli batter.

Thus, any combination of Lactobacillus plantarum strain and Leuconostoc spp strain(s) (and ratio thereof) can be used as long as the pH of the lactic-acid fermented batter obtained by the present method can reach a value between 3.5 and 4.5 after incubation. As example, the Lactobacillus plantarum strain and the Leuconostoc spp strain(s) can be selected together using the assay A described herein. In an embodiment, the Lactobacillus plantarum strain and Leuconostoc spp strain(s) of the culture or kit-of-part are selected such that when added to the model medium (the Dosa/Idli batter medium of assay A), a culture comprising or consisting of said Lactobacillus plantarum strain and said Leuconostoc spp strain(s) enables said model medium to reach a pH between 3.5 and 4.5, 16 hours after its addition, in particular to reach a pH between 3.6 and 4.4 or between 3.8 and 4.2, 16 hours after its addition, when tested by assay A. In an optional embodiment, in combination with the previous one, the Lactobacillus plantarum strain and the Leuconostoc spp strain(s), and in particular ratio thereof, are selected such that when added to the model medium (the Dosa/Idli batter medium of assay A), a culture comprising or consisting of said Lactobacillus plantarum strain and said Leuconostoc spp strain(s) produces CO₂ in an amount that is less than 15% vol., in particular that is between 2 and 15% vol., 16 hours after its addition, as tested by assay A.

In an embodiment, the Lactobacillus plantarum strain of the culture or kit-of-part is the Lactobacillus plantarum strain deposited at the DSMZ under accession number DSM25833 on Apr. 3, 2012 or a variant of said DSM25833 strain as defined herein.

In an embodiment, the only microorganisms contained in the culture or kit-of-part of the invention are the Lactobacillus plantarum strain and the Leuconostoc spp strain(s) as defined herein. In another embodiment, the culture or kit-of-part of the invention comprises, in addition to the Lactobacillus plantarum strain and the Leuconostoc spp strain(s) as defined herein, at least one additional microorganism(s) and in particular 1, 2, 3, 4, 5 or 6 additional microorganism(s). In a particular embodiment, said at least one additional microorganism is a yeast, in particular a yeast from the Debaryomyces genus. In a particular embodiment, said at least one additional microorganism is a lactic acid bacteria, in particular a lactic acid bacteria of the Pediococcus genus. In an embodiment, the culture or kit-of-part of the invention comprises or consists of the Lactobacillus plantarum strain and the Leuconostoc spp strain(s) as defined herein and a yeast, in particular a yeast from the Debaryomyces genus. In a particular embodiment, the culture or kit-of-part of the invention comprises or consists of the Lactobacillus plantarum strain and the Leuconostoc spp strain(s) as defined herein and a lactic acid bacteria, in particular a lactic acid bacteria of the Pediococcus genus. In a particular embodiment, the culture or kit-of-part of the invention comprises or consists of the Lactobacillus plantarum strain and the Leuconostoc spp strain(s) as defined herein, a yeast, in particular a yeast from the Debaryomyces genus and a lactic acid bacteria, in particular a lactic acid bacteria of the Pediococcus genus. When additional microorganism(s) as defined herein are mixed together with Lactobacillus plantarum strain and the Leuconostoc spp strain(s) as defined herein (within a culture), said additional microorganism(s) are in a concentration (in cfu/g) that is, for each microorganism(s) and independently from each other, less than the concentration of the Lactobacillus plantarum strain and less than the concentration of the Leuconostoc spp strain(s).

The invention is also directed to the use of a culture or kit-of-part comprising or consisting of a Lactobacillus plantarum strain and Leuconostoc spp strain(s) as defined herein, as a lactic acid fermenting culture, to manufacture a millet-, sorghum-, lentil-, pea-, rice- or teff-based lactic acid-fermented batter, in particular a Dosa or Idli batter. In a particular embodiment, said culture or kit-of-part comprising or consisting of a Lactobacillus plantarum strain and Leuconostoc spp strain(s) as defined herein is used herein to manufacture a millet-, sorghum-, lentil-, pea-, rice- or teff-based lactic acid-fermented batter, in particular a Dosa or Idli batter presenting an extended shelf life as compared to a control millet-, sorghum-, lentil-, pea-, rice- or teff-based lactic acid-fermented batter, in particular a Dosa or Idli batter. Said culture or kit-of-part can be used in the adding step b) of any method described herein.

By “control lactic-acid fermented batter”, it is meant a lactic-acid fermented batter as defined herein which has been manufactured from the same grain(s) and according to the same process [production of the batter and incubation step] as a lactic-acid fermented batter of the invention, with the exception of step b). Thus, control lactic-acid fermented batter encompasses lactic-acid fermented batter manufactured:
without added strains [i.e., without step b)]; or
with the addition in step b) of one or more strains which are neither a Lactobacillus plantarum strain nor Leuconostoc spp strain(s) as defined herein. In particular, the concentration of added or inoculated strains to manufacture the lactic-acid fermented batter of the invention and the control lactic-acid fermented batter is the same.

It is a particular advantage of the added strains of the invention, i.e., the Lactobacillus plantarum strain and Leuconostoc spp strain(s) as defined herein, to provide a lactic acid-fermented batter having an extended shelf life. In particular, the lactic acid-fermented batter manufactured with addition of Lactobacillus plantarum strain and Leuconostoc spp strain(s) as defined herein has a shelf life extended as compared to the shelf life of a control lactic acid-fermented batter manufactured without added strains. In particular, the lactic acid-fermented batter manufactured with addition of Lactobacillus plantarum strain and Leuconostoc spp strain(s) as defined herein has a shelf life extended as compared to the shelf life of a control lactic-acid fermented batter manufactured with added strains other than a combination of Lactobacillus plantarum strain and Leuconostoc spp strain(s) as defined herein.

By “shelf life” it is meant the length of time (in days) for which a lactic-acid fermented batter—obtained or obtainable by the method to produce, a millet-, sorghum-, lentil-, pea-, rice- or teff-based, lactic acid-fermented, batter, as described herein—can be stored before becoming unfit for use or consumption by the consumers. This length of time is calculated starting from the filing of the lactic acid-fermented batter into pouches. In a particular embodiment, the shelf life of the batter in the pouches is determined at refrigerated temperature, such as between 2 and 10° C.

A lactic acid-fermented batter is considered to be unfit for use or consumption, when either one or several of the following parameters are met:
the batter is no more homogenous, with a clear separation between water and flours, and/or
a decoloring of the batter is observed, and/or
a foamy texture of the batter (too much gas production) instead of a liquid texture is observed.

By “extended shelf life”, it is meant a shelf life as defined above which is increased of at least 50%, at least 80%, at least 100%, at least 200% or at least 300% as compared to the shelf life of a control lactic acid-fermented batter manufactured, in particular according to a control lactic acid-fermented batter manufactured without added strains or the shelf life of a lactic-acid fermented batter manufactured with added strains other than a combination of Lactobacillus plantarum strain and Leuconostoc spp strain(s) as defined herein.

### Deposit and Expert Solution

The following deposit was made according to the Budapest treaty on the international recognition of the deposit of microorganisms for the purposes of patent procedure.
Lactobacillus plantarum strain deposited under accession number DSM25833 on Apr. 3, 2012, at the DSMZ [Deutsche Sammlung von Mikroorganismen and Zellkulturen GmbH, Inhoffenstrasse 7B, D-38124 Braunschweig—Germany]. We hereby confirm that the depositor, Danisco Deutschland GmbH (of Busch-Johannsen-Strasse 1, D-25899 Niebüll, Germany) has authorised the Applicant (DuPont Nutrition Biosciences ApS, Langebrogade 1, DK-1411 Copenhagen K, Denmark) to refer to the deposited biological material in this application and has given his unreserved and irrevocable consent to the deposited material being made available to the public. The DSM25833 L. plantarum strain is from the DuPont/Danisco collection. This strain was obtained from the former collection of Wiesby (acquired by Danisco), and sourced from Germany in 1990.

In respect to those designations in which a European Patent is sought, a sample of the deposited microorganism will be made available until the publication of the mention of the grant of the European patent or until the date on which application has been refused or withdrawn or is deemed to be withdrawn, only by the issue of such a sample to an expert nominated by the person requesting the sample, and approved either i) by the Applicant and/or ii) by the European Patent Office, whichever applies (Rule 32 EPC).

### EXPERIMENTAL

### Example 1. Analysis of Different Compositions of Lactobacillus plantarum Strain and Strains Belonging to Leuconostoc mesenteroïdes Species in Culture Selection for Batter Fermentation

### A. Laboratory Dosa/Idli Fermented Wet Batter Selection Assay (Assay A)

Parboiled rice grains (Top Budget brand) were soaked with sterile water (3 parts of grains, 1 part of water) during 4 hours at 25° C. Dehulled black gram (Golden harvest Daily) were soaked with sterile water (3 parts of gram/1 part of water) during 4 hours at 25° C. Each soaked product was drained. The final ratio between grains and water was adjusted to 1 part of soaked grains or gram for 1.25 part of sterile water. Then after, rice soaked grains and soaked black gram were wet grinded separately with a wet grinder device (type Butterfly brand, matchless). The two products are mixed together, after having being grinded separately, at a ratio of 3 parts of rice batter with 1 part of black gram batter. In the final mix batter, 1% (W/W) NaCl and 0.1% (W/W) fenugreek powder (Valga brand, india) were added to obtain the final recipe of Dosa/Idli batter medium (model medium). A culture (provided as a lyophilized concentrate, the concentration of which is between 10⁸ and 10¹² cfu/g of culture) was directly inoculated at a rate of 10⁶ cfu/ml of final batter medium. 100 ml of batter was then placed in specific flask of 500 ml equipped with a pH probe and a system to measure CO₂ in the head space (BCP-CO₂, gas sensor system provided by Bluesens GmbH company). The BCP-CO₂ system was used to measure the concentration in CO₂ in a gas for a range of 0-25% (V/V) CO₂ at 25° C. by IR light intensity absorption inside a specific closed cap sealed on the top of the flask. The flask was displayed in a water bath thermo-regulated at a temperature of 30° C.±0.5° C. pH evolution was measured using an on-line measurement system, Cinac system (CINAC, an automated system for control of lactic starters; Corrieu G. et al.; Process Magazine; 1992, 1068; p. 24-27) and CO₂ production was assessed with the CO₂ measurement system (gas sensor system provided by Bluesens GmbH company). pH and CO₂ concentration evolutions were plotted versus time.

The following criteria have been used to confirm the culture design and culture selection for batter application:
a pH between 3.5 and 4.5, preferably between 3.8 and 4.2, after 16 h fermentation time
a CO₂ production which is less than 15% vol. (in particular between 2-15%) after 16 h fermentation time
   B. Different Compositions of 3 Strains Belonging to Leuconostoc mesenteroïdes and One Strain Belonging to Lb. plantarum

3 different compositions have been designed (Table 1) and used as a direct inoculum in assay A [with parboiled Rice grains from Top Budget brand—DLUO 04/06/16 and dehulled black gram from Golden harvest Daily lot SMY 7376—SMY Future Consumer Enterprise Ltd]. Each strain of the different compositions was provided as a lyophilized concentrate (concentration between 10⁸ and 10¹² cfu/g of strain); the strains were then mixed as a lyophilized concentrate according to the desired ratio. Values of pH and CO₂ concentration determined by assay A—after 16 h of fermentation with these compositions or without inoculation (negative control)—were used as criteria to validate the designed cultures (Table 2).

TABLE 1
Composition of inoculum in cfu/ml of batter

| Composition | 1 | 2 | 3 |
|---|---|---|---|
| Leuconostoc mesenteroïdes dextranicum | 3.10⁴ | 3.10⁴ | 3.10⁴ |
| DGCC 4636 | | | |
| Leuconostoc mesenteroïdes dextranicum | 3.10⁴ | 3.10⁴ | 3.10⁴ |
| DGCC 4634 | | | |
| Leuconostoc mesenteroïdes DGCC 4627 | 4.10⁴ | 4.10⁴ | 4.10⁴ |
| Lactobacillus plantarum DSM25833* | 9.10⁵ | — | — |
| Lactobacillus plantarum DGCC 262 | — | 9.10⁵ | — |
| Lactobacillus plantarum DGCC 4715 | — | — | 9.10⁵ |

*strain deposited on Apr. 3, 2012 at the DSMZ

TABLE 2
Results of acidification and CO₂ production for 3
different compositions of Lb. plantarum and Leuconostoc
spp strains and for a negative control.

| | | pH 16 h | | % CO₂ (16 h) (V/V) | |
|---|---|---|---|---|---|
| | n | average | Stdev | average | Stdev |
| Composition 1 | 4 | 4.04 | 0.000 | 6.3 | 1.44 |
| Composition 2 | 4 | 4.00 | 0.019 | 8.9 | 0.61 |
| Composition 3 | 3 | 4.01 | 0.009 | 11.0 | 2.03 |
| Negative control | 3 | 4.72 | 0.157 | 6.2 | 1.13 |

After 16 h of fermentation, there was no significant difference in term of pH between the 3 different compositions. The 3 compositions enabled to obtain a pH around 4.0 after 16 h of fermentation (at t=0, pH is about 5.90). In absence of inoculation, the obtained pH was around 4.72, which is typical of an acidification resulting from the presence of indigenous microorganisms.

Regarding the amount of CO₂ produced, there was a significant difference between the compositions Composition 1 made with Lb. plantarum DSM25833 was producing significantly less CO₂ than composition 3 (6.35% versus 11.04%). Composition 2 was ranked between the two previously mentioned.

The 3 compositions fulfilled the fixed criteria and were therefore considered suitable for batter application.

The combination 1 based on the Lb. plantarum DSM25833 strain gave a good balance between acidification and CO₂ production, and was thus selected for further experiments.

### Example 2: Implementation of a Lactobacillus plantarum/Leuconostoc mesenteroïdes Species Composition in Various Fermented Batter Productions

Composition 1 as described in example 1B was used as a direct inoculum in various batter productions based on millet. Each strain of the composition 1 was provided as a lyophilized concentrate (concentration between 10⁸ and 10¹² cfu/g of strain); the strains were then mixed as a lyophilized concentrate to obtain the desired ratio. The same protocol as assay A was used, with the following substrates (3 parts of millet batter for 1 part of black gram batter) instead of the ones described in example 1:
Foxtail millet (Setaria italic)* [Hulled and sortexed, Sresta Natural Bioproduct GIC2015112] and dehulled black gram [Spencer's lot 4301075624 04/2014]
Little millet (Panicum sumatrense)* [Hulled and sortexed Sresta Natural Bioproduct GIC 2015141] and dehulled black gram [Spencer's lot 4301075624]
Barnyard millet (Echinochlo autilis)* [Hulled and sortexed Sresta Natural Bioproduct GIC2015102] and dehulled black gram [Spencer's lot 4301075624]
Kodo millet (paspalum setaceum)* [Sresta Natural Bioproduct, GGL2014011] and dehulled black gram [Spencer's lot 4301075624]
Mixed millet (a mix of foxtail, little, barnyard and kodo millet) [Sresta Natural Bioproduct GIA 2015061] and dehulled black gram [Spencer's lot 4301075624]*: belonging to the Poaceae cereal family

The pH achieved after 16 h and 24 h of fermentation were determined for each batter production (Table 3). Regarding fermented batter production, it is acceptable to obtain a pH value between 3.5 and 4.5, in particular between 3.6 and 4.4, and more preferably between 3.8 and 4.2, after a 14 to 30 h fermentation time.

TABLE 3
Results of acidification with composition 1 in different batter productions.

| | Foxtail millet | Little millet | Barnyard | Kodo millet | Mixed millet |
|---|---|---|---|---|---|
| | and black | and black | millet and | and black | and black |
| pH | gram | gram | black gram | gram | gram |
| t = 0 | 6.12 | 6.04 | 5.89 | 5.83 | 6.07 |
| t = 16 h | 4.37 | 4.83 | 3.98 | 4.09 | 4.10 |
| t = 24 h | 3.85 | 4.09 | 3.81 | 3.70 | 3.85 |

The pH achieved after 16 h with mixed millet, barnyard millet or Kodo millet was similar to the pH achieved for a rice-based batter production. The time needed to achieve the more preferred pH is however longer but acceptable—when using foxtail millet or little millet as substrate.

The type of substrates used during batter production influences the pH decrease and the time to obtain the most preferred pH (i.e., 3.8 and 4.2). This example confirms that composition 1 enables to obtain the most preferred pH range with all tested substrates in less than 24 hours.

### Example 3: Analysis of Different Ratios of Lactobacillus plantarum Strain and Strains Belonging to Leuconostoc mesenteroïdes Species in Culture Selection for Batter Fermentation

Various ratio of the strains contained in composition 1 of example 1B above have been tested according to assay A, with parboiled rice grains from Top Budget brand—DLUO 04/06/16 and dehulled black gram from Spencer's 4301075624 Apr. 2014. Three ratios Lb. plantarum over Leuconostoc mesenteroïdes were selected: 9/1, 1/1 and 7/3 (see Table 4). Each strain of the different compositions is provided as a lyophilized concentrate (concentration between 10⁸ and 10¹² cfu/g of strain); the strains are then mixed as a lyophilized concentrate according to the desired ratio.

TABLE 4
Compositions of 3 inoculum (in cfu/ml of batter)

| Composition | 1 | 11 | 12 |
|---|---|---|---|
| Leuconostoc mesenteroïdes dextranicum | 3.10⁴ | 1.6.10⁴ | 1.10⁴ |
| DGCC 4636 | | | |
| Leuconostoc mesenteroïdes dextranicum | 3.10⁴ | 1.6.10⁴ | 1.10⁴ |
| DGCC 4634 | | | |
| Leuconostoc mesenteroïdes DGCC 4627 | 4.10⁴ | 1.7.10⁴ | 1.10⁴ |
| Lactobacillus plantarum DSM25833 | 9.10⁵ | 5.10⁵ | 7.10⁵ |
| Ratio Lb. Plantarum/Leuconostoc spp | 9/1 | 1/1 | 7/3 |
| strains | | | |

pH and CO₂ concentration after 16 h have been determined as described in assay A and reported in Table 5.

TABLE 5
Results of acidification and CO₂ production for 3 different
Lb. plantarum/Leuconostoc spp strains ratios

| | Ratio | pH 16 h | % CO₂ 16 h |
|---|---|---|---|
| Composition 1 | 9/1 | 3.98 | 10.7 |
| Composition 11 | 1/1 | 3.96 | 13.6 |
| Composition 12 | 7/3 | 3.97 | 13.7 |

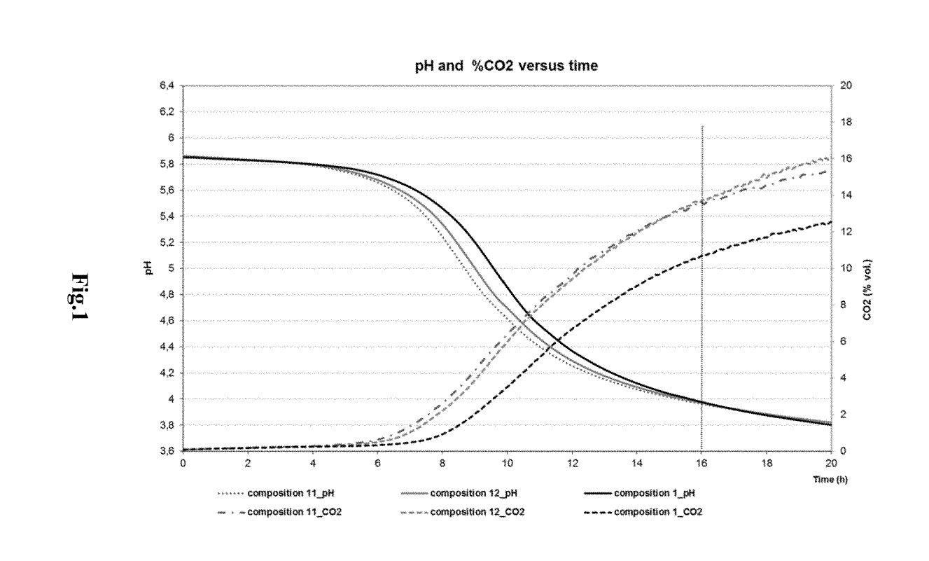

It can be noticed that the pH achieved after 16 h of fermentation was independent of the ratio Lb. plantarum/Leuconostoc spp. Therefore, the 3 compositions (1, 11 and 12) fulfilled the criteria and were therefore considered suitable for batter application. Interestingly, the % CO₂ after 16 h seems to slightly decrease when the ratio Lb. plantarum/Leuconostoc mesenteroïdes is increased. FIG. 1 shows the evolution versus time of the pH and the % CO₂ of the 3 compositions (at t=0, pH is about 5.85 and % CO₂ is 0).

It was also observed that the change of dehulled black gram between example 1B and example 3 had an impact on the level of % CO₂ when using the same composition (composition 1). Indeed, 16 h after fermentation, in example 1B the level of % CO₂ was 6.3 whereas in example 3 the level of % CO₂ was 10.7. This difference clearly shows that the nature and the origin of the substrate used influence the level of produced CO₂, even if the % CO₂ is still in the range used as a selection criteria (less than 15% vol., in particular between 2-15%).

### Example 4) Analysis of Lactobacillus plantarum Strain and Strains Belonging to Leuconostoc mesenteroïdes Species Supplemented with Other Lactic Acid Bacteria or Yeast in Culture Selection for Batter Fermentation

Composition 1 described above was compared with a negative control (no inoculation) and the 3 compositions as follows (Table 6):
composition 1 supplemented with a Pediococcus pentosaceus (composition 111)
composition 1 supplemented with another Pediococcus pentosaceus (composition 112)
composition 1 supplemented with a yeast belonging to Debaryomyces hansenii (composition 113)

The 4 compositions (1, 111, 112 and 113) have been tested as direct inoculum according to assay A with parboiled rice grains from Top Budget brand—DLUO 04/06/16 and dehulled black gram from Golden harvest Daily—lot SMY 7376, and compared with an assay A done without culture inoculation (negative control). Each strain of the different compositions is provided as a lyophilized concentrate (concentration between 10⁸ and 10¹² cfu/g of strain); the strains and/or yeast are then mixed as a lyophilized concentrate according to the desired ratio

TABLE 6
Composition in cfu/ml of batter

| Composition | 1 | 111 | 112 | 113 |
|---|---|---|---|---|
| Leuconostoc mesenteroïdes | 3.10⁴ | 3.10⁴ | 3.10⁴ | 3.10⁴ |
| dextranicum DGCC 4636 | | | | |
| Leuconostoc mesenteroïdes | 3.10⁴ | 3.10⁴ | 3.10⁴ | 3.10⁴ |
| dextranicum DGCC 4634 | | | | |
| Leuconostoc mesenteroïdes | 4.10⁴ | 4.10⁴ | 4.10⁴ | 4.10⁴ |
| DGCC 4627 | | | | |
| Lactobacillus plantarum | 9.10⁵ | 9.10⁵ | 7.10⁵ | 7.10⁵ |
| DSM25833 | | | | |
| Pediococcus pentosaceus | — | — | 2.10⁵ | — |
| DGCC5688 | | | | |
| Pediococcus pentosaceus | — | — | — | 2.10⁵ |
| DGCC 5799 | | | | |
| Debaryomyces hansenii | — | 5.10³ | — | — |
| DGCC 3541 | | | | |

pH and CO₂ concentration after 16 h have been determined as described in assay A and reported in Table 7.

TABLE 7
Results of acidification and CO₂ production for
4 different compositions and a negative control

| Inoculum | pH (16 h) | % CO2 (16 h) |
|---|---|---|
| Composition 1 | 4.09 | 5.3 |
| Composition 111 | 4.01 | 11.6 |
| Composition 112 | 4.02 | 6.9 |
| Composition 113 | 4.04 | 7.3 |
| Negative control | 4.76 | 7.7 |

As shown in Table 7, all the compositions tested allow achieving a pH after 16 h in the preferred range of 3.8-4.2 and a % CO₂ level comprised in the preferred interval of 2-15%. The negative control does not enable to reach a pH below 4.76 after 16 h of fermentation.

### 5) Example of Pilot Production of DOSA/IDLI Batter with Composition 1

DOSA/IDLI batter was produced by using the following recipe for a batch of 35 L: idli rice 5.6 kg, Tukda rice 5.6 kg, urad dahl 2.6 kg and salt 2.45 kg. Rice grains and urad dahl were autoclaved at 120° C.; 30 min after a washing step. The soaking step lasted 4-6 h for each raw material and then each raw material is wet grinded separately to obtain a batter. Culture and salt have been added during the mixing step of the rice and urad dahl batters. The fermentation has been carried out at ambient temperature after dispatching the batter in 1 L commercial sachet. Composition 1 as described above (strains and ratio) was provided as a lyophilized concentrate of 1.10¹⁰ cfu/g of composition. This composition 1 was used as direct inoculum (inoculation level: 1.10¹¹ cfu/100 kg of batter) and compared to a control culture—currently used industrially by DOSA/IDLI batter manufacturers—consisting of Pediococcus pentosaceus and Candida versatilis.

### A. Quality of Fried Dosa/Steamed Idli

The batter obtained with composition 1 and the batter obtained with control culture were stored for 4 days and 25 days at a temperature range 7-12° C. DOSA and IDLI were produced respectively by frying the batter in a pan and steaming the batter with a specific steamer device. After 4 days of storage of the batter, the quality of the Dosa and IDLI produced with the control culture was similar to the one produced with composition 1. After 25 days of storage of the batter, it was not possible to produce satisfactory DOSA and IDLI with the control culture. Indeed, during the frying step of the batter (DOSA), the pancake was not able to be correctly formed in the pan; the pancake broke in small pieces due to lack of cohesiveness of the batter used. For IDLI production, the bowl obtained after steaming did not exhibit enough cohesiveness in order to be taken of hold by hands; the bowl broke just under a small finger pressure. In contrast, the batter produced with combination 1 still allowed manufacturing high quality DOSA and IDLI. These data show that the use of a composition based on Lactobacillus plantarum strain and strains belonging to Leuconostoc mesenteroïdes species (such as composition 1) during batter manufacturing increases the shelf life of obtained batter while preserving the quality of the obtained DOSA and IDLI.

### B. Volume Extension of Pouches During Storage

The sachets were monitored for volume extension during storage up to 25 days at ambient temperature (24-28° C.). Table 8 reports the magnitude of volume extension assessed by laboratory technician [−: no volume extension −+; slight extension; ++: medium extension; ++++: huge extension].

TABLE 8
magnitude of volume extension of a sachet
of DOSA/IDLI wet batter after storage.

| | control culture | Composition 1 |
|---|---|---|
| day 1 to 5 | − | − |
| day 10 to 15 | ++ | + |
| day 23 to 25 | ++++ | ++ |

These data shows that the use of a composition based on Lactobacillus plantarum strain and strains belonging to Leuconostoc mesenteroïdes species (such as composition 1) enables to control the production of gas—and thus the extension of the sachet—during storage. The control of volume extension is a key feature to enhance shelf life of commercial DO SA/IDLI wet batter. Indeed, limiting the puffing out of the sachet during storage prevents the wet batter release due to sachet cracking.

1. A method to produce a millet-, sorghum-, lentil-, pea-, rice- or teff-based, lactic acid-fermented batter, wherein:
the method comprises:
a) providing a millet-, sorghum-, lentil-, pea-, rice- or teff-based batter;
b) adding to said batter a Lactobacillus plantarum strain and Leuconostoc spp strain(s); and
c) incubating said batter obtained in b) at an appropriate temperature to obtain by lactic acid fermentation a millet-, sorghum-, lentil-, pea-, rice- or teff-based lactic acid-fermented batter; and
each of the Lactobacillus plantarum strain and of Leuconostoc spp strain(s) is added in step b) at a concentration of at least 10⁵ cfu/g of batter.

2. The method according to claim 1, wherein the Lactobacillus plantarum strain and the Leuconostoc spp strain(s) are selected such that when added to a model medium of Assay A, a culture comprising said Lactobacillus plantarum strain and said Leuconostoc spp strain(s) enables said model medium to reach a pH between 3.5 and 4.5 16 hours after addition of the culture when tested by Assay A.

3. The method according to claim 1, wherein the Lactobacillus plantarum strain and the Leuconostoc spp strain(s) are added in step b) as separate cultures.

4. The method according to claim 1, wherein the ratio of the Lactobacillus plantarum strain over the Leuconostoc spp strain(s) is between 1:1 and 20:1 (cfu/cfu).

5. The method according to claim 1, wherein the Lactobacillus plantarum strain is the strain deposited at the DSMZ under accession number DSM25833 on Apr. 3, 2012 or a variant of said DSM25833 strain.

6. The method according to claim 1, wherein the Lactobacillus plantarum strain and the Leuconostoc spp strain(s), either as separate cultures or as a mixture, are added in step b) as a frozen or dried concentrate.

7. The method according to claim 1, wherein said batter of step a) is a lentil-based batter or pea-based batter.

8. The method according to claim 1, wherein said batter of step a) is a rice-based batter, teff-based batter or combination thereof.

9. The method according to claim 1, wherein the batter of step a) is:
a paste of rice and black gram, or
a paste of rice flour and bengal gram.

10. The method according to claim 9, wherein the method comprises:
a) providing a paste of a rice flour and black gram flour,
b) adding the Lactobacillus plantarum strain and the Leuconostoc spp strain(s) to said paste, and
c) incubating said paste at an appropriate temperature to obtain a Dosa or Idli batter.

11. A millet-, sorghum-, lentil-, pea-, rice- or teff-based lactic acid-fermented batter obtained by the method of claim 1.

12. A millet-, sorghum-, lentil-, pea-, rice- or teff-based, lactic acid-fermented batter, wherein the batter:
comprises Lactobacillus plantarum strain and Leuconostoc spp strain(s).

13. A culture or kit-of-part suitable for the manufacture of a millet-, sorghum-, lentil-, pea-, rice- or teff-based lactic acid-fermented batter, wherein:
the culture or kit-of-part comprises a Lactobacillus plantarum strain and Leuconostoc spp strain(s); and
said Lactobacillus plantarum strain and Leuconostoc spp strain(s) are selected such that when added to a model medium of Assay A, a culture comprising said Lactobacillus plantarum strain and said Leuconostoc spp strains) enables said model medium to reach a pH between 3.5 and 4.5 16 hours after addition of the culture when tested by Assay A.

14. The culture or kit-of-part according to claim 13, wherein the Lactobacillus plantarum strain is the strain deposited at the DSMZ under accession number DSM25833 on Apr. 3, 2012 or a variant of said DSM25833 strain.

15. The culture or kit-of-part according to claim 13, wherein the culture or kit-of-part further comprises at least one yeast such as a yeast and/or at least one additional lactic acid bacteria.

16. (canceled)

17. The method according to claim 1, wherein the batter obtained in step c) has a pH of between 3.5 and 4.5.

18. The method according to claim 1, wherein the Lactobacillus plantarum strain and the Leuconostoc spp strain(s) are added in step b) as a mixture.

19. The method according to claim 1, wherein said batter of step a) is a black gram-based batter or bengal gram-based batter.

20. A batter according to claim 11, wherein the batter is a Dosa or Idli batter.

21. A batter according to claim 12, wherein the batter is a Dosa or Idli batter.

22. A batter according to claim 12, wherein the batter comprises the Lactobacillus plantarum strain and Leuconostoc spp strain(s) at a total concentration of at least 10⁷ cfu/g.

23. The culture or kit-of-part according to claim 13, wherein the batter is a Dosa or Idli batter.

24. The culture or kit-of-part according to claim 13, wherein the culture or kit-of-part further comprises a yeast from the Debaryomyces genus and/or a lactic acid bacteria of the Pediococcus genus.
